(19) United States
(12) Patent Application Publication
(10) Pub. No.: US 2020/0158597 A1
(43) Pub. Date: May 21, 2020

(54) Optical Analysis System For HOE Quality Appraisal

(71) Applicant: LUMINIT LLC, Torrance, CA (US)

(72) Inventors: MATTHEW STEVENSON, LONG BEACH, CA (US); JUAN RUSSO, TORRANCE, CA (US); SETH COE-SULLIVAN, TORRANCE, CA (US)

(21) Appl. No.: 16/688,588

(22) Filed: Nov. 19, 2019

Related U.S. Application Data
(60) Provisional application No. 62/769,083, filed on Nov. 19, 2018.

(51) Int. Cl. G01M 11/02; G03H 1/22

(52) U.S. Cl. CPC G01M 11/0271; G03H 1/2202; G03H 2223/15; G03H 2223/16; G03H 2001/2247

(57) ABSTRACT

This application discloses an automated system for measuring the quality of an HOE using incoherent light and a camera or image screen.

### CROSS-REFERENCE TO RELATED APPLICATION

This application claims priority to U.S. Provisional Patent Application Ser. No. 62/769,083 filed Nov. 19, 2018, whose disclosure is incorporated herein by reference.

### TECHNICAL FIELD

This application is directed to an apparatus and method for the analysis of the quality of a holographic optical element (HOE). More specifically, this application relates to an apparatus and method for in-line quality testing of diffraction uniformity of an HOE in a mass production setting.

### BACKGROUND

It is estimated that the combined revenues for sales of augmented reality (AR), virtual reality (VR) and smart glasses will approach $80 billion by the year 2025. About half of that revenue is directly proportional to hardware of the devices and the optics are key. However, despite this popularity and huge demand, such devices remain difficult to manufacture. One reason is that traditional optical elements are limited to the laws of refraction and reflection, which require cumbersome custom optical elements that are difficult to fabricate to form a usable image in the wearer's visual field. Another reason is that refractive optical materials are heavy in weight. Yet another reason is that reflective optical trains result in bulky and nonergonomic designs. These limitations of traditional optical elements result in devices that are less than satisfactory to the public.

However, the use of HOE materials in the manufacturing of such devices can solve many of these problems. The flexibility provided by the HOE fabrication and analysis described herein facilitates the production of an attractive, conformable, inexpensive, and easy to use consumer product. HOEs are thin and can be custom fabricated for ergonomic input and output angles with relative ease. However, there are no methods or systems to analyze the quality of HOEs in a mass production environment, which are sorely needed. Current individual monitoring of the quality of HOEs is cumbersome and time- consuming in the performance of the individual testing, in the analysis of the data, and in the interruption of the manufacturing process. The present system addresses the need for an effective solution to the problem of the inability to test the quality of HOEs quickly, simply, and precisely.

### BRIEF SUMMARY

The present application is directed to an apparatus and system that facilitates the accurate measurement of the quality of an HOE in a single or mass production environment. One embodiment of the apparatus includes an incoherent light source, optical transformation optics, a narrow band filter, and a camera or an image screen. One or more translation stages can also be added for moving the HOE.

Also disclosed is a method of measuring quality of a holographic optical element that involves illuminating an active area of an HOE with light of a very narrow wavelength range, wherein the HOE diffracts the light into a camera or onto an image screen; and detecting an image depicting quality or uniformity of the HOE. The HOE can be evaluated at different positions by means of one or more translations in space.

Another embodiment is directed to a method of assaying the quality of a population of holographic optical elements comprising illuminating an HOE with light having a very narrow wavelength range, wherein the light is diffracted back into a camera or onto an image screen, and detecting quality of an image for each member of the population of holographic optical elements.

The optical analysis system of this application has several benefits and advantages. As the HOE moves from the lab and into mass production, faster and more accurate testing methods and equipment is needed to qualify HOEs for customer use. Often, the primary consideration for customer acceptance is the performance of the parts. The system described here was developed to ascertain the quality of these parts in a simple yet exacting manner, which is suitable for single or mass production environments.

### BRIEF DESCRIPTION OF THE DRAWINGS

FIG. 1 is a graphical comparison of the incoherent light source (M625F2) vs the filtered light source as of the system described herein vs a laser (coherent light source).

FIG. 2 is a graphical comparison of the laser source temperature dependence.

FIG. 3 illustrates an image of the output of an Optical Analysis System.

FIG. 4 shows individual components of this system.

FIG. 5 shows a system in which the camera is translated.

FIG. 6 shows HOE measurement.

FIG. 7 shows astigmatism analysis.

### DETAILED DESCRIPTION OF EXEMPLARY EMBODIMENTS

The present application relates to an apparatus and method for accurately measuring the quality of an HOE in a single or mass production environment. To accomplish this, the apparatus illuminates the active area of the HOE with incoherent light of a very narrow wavelength range, so as to simulate laser illumination of the HOE and the corresponding image without actually using a laser light. The HOE then diffracts this light and the diffracted beam can be imaged on a piece of paper, screen or with a camera sensor to provide an image that directly reflects the uniformity and quality of the HOE being tested.

One embodiment is a system for analyzing quality of a holographic optical element comprising an incoherent light source, optical transformation optics, a narrow band filter, and a camera or an image screen. The optical transformation optics can include a spatial filter, a fiber optic cable, one or more lenses, or a mixture thereof. In one embodiment, the optical transformation optics comprises a fiber optic cable. In another embodiment, the optical transformation optics comprises one or more lenses. In yet another embodiment, the optical transformation optics comprises a spatial filter. In still another embodiment, the optical transformation optics comprises a spatial filter, a fiber optic cable, one or more lenses, or a mixture thereof. In another embodiment, the system further includes one or more translational stages.

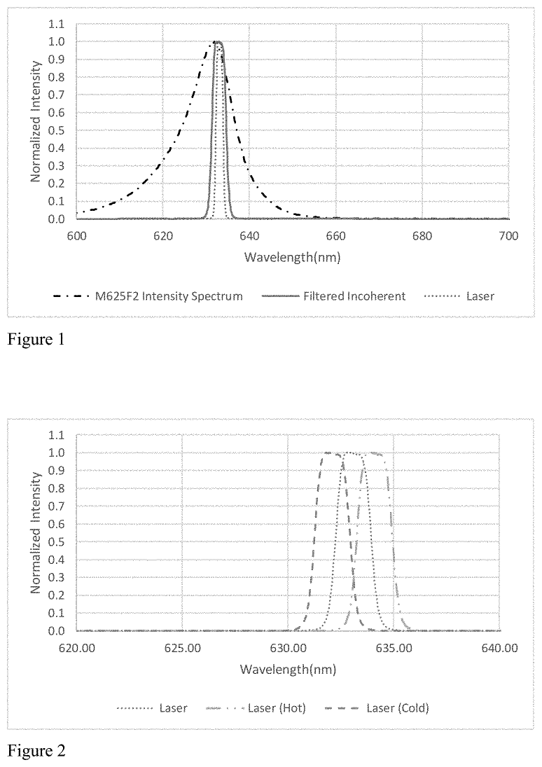

The individual components of this system, as shown in FIG. 1, can include:

Incoherent light source: A monochrome LED is an example of an incoherent light source having an output suited to fiber coupling (i.e. SMA connector) but a multicolor LED can be used also. An example part is the Thorlabs M625F2 that consists of a single LED with spectrum centered at 625 nm that is coupled to the optical fiber for a red illuminator. The emission spectrum is shown in Figure

[symbol]

Optical transformation optics: The optics transform the light source wavefront into a wavefront suitable to assess the holographic optical element. The transformation optics should be able to control the parameters of the output wavefront such as spot size, wavefront aberration, etc. In the case of a focusing holographic optical element, the suitable wavefront is a diverging source. An example of suitable transformation optics in this case is a fiber optics cable such as the Thorlabs M38L02. In this case, the diameter of the fiber optic cable determines the level of detail in the image produced by the system. It has been observed that as the diameter of the fiber increases, the image increases and highlights smaller-scale features.

Narrow band filter. A narrow-band filter reduces the light incident on the sample to a very narrow bandwidth (2-3 nm) as to simulate laser light without coherence self-interference. The filter should be of sufficient size as to encompass all of the light from the transformation optics. The preferred type of filter is a thin film stack on glass. An example filter is the Thorlabs FL632.8-3. This is a bandpass filter that transmits a well-defined wavelength band of light while rejecting unwanted radiation. The operating temperature of the filter is very wide starting from −50 C to 80 C without significant deviation of their spectral performance. This is in contrast to that of a laser source as shown in FIG. 2, which is a graph of laser source temperature dependence. A laser source is sensitive to operating temperature. The peak wavelength changes by up to 2 nm in a temperature range of 20-30 degrees C. In comparison, the operating temperature of the filter in the system described herein is very wide starting from −50 C to 80 C without significant deviation of their spectral performance.

Another component of this systems is a computer or a camera or an image screen: In the case of a camera, the sensor should have sufficient resolution to capture the details of the image required (i.e. 2048×2048). The camera or computer has a large sensor (0.5″×0.5″). An example of a suitable camera is the Edmund Optics EO-4010 Monochrome USB 3.0 Camera. In another embodiment, a diffusive sheet (i.e. Luminit 80 degree diffuser) can be used instead of a camera, as shown in FIG. 2, to capture an image from the HOE, which is displayed on the sheet.

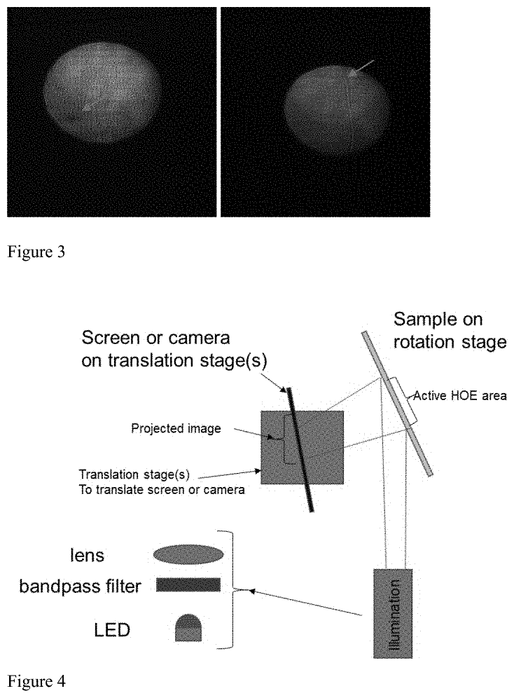

The image in FIG. 3 shows an example HOE image from the quality inspection system described here. Any defects are clearly visible in the image as deviations from a flat, white background. Blemishes (left) and undesirable artifacts such as lines (right) are highlighted with arrows.

One example system was constructed using a selection of optical mounting hardware, which was attached to an optical breadboard. The mounting hardware was chosen to allow adjustments during development, but also the components could be mounted on custom-designed permanent hardware.

The system above can be used in a method of measuring the quality of a holographic optical element by:(a) illuminating an active area of an HOE with incoherent light of a very narrow wavelength range wherein the HOE diffracts the light into a camera or onto an image screen; and (b) detecting an image depicting quality or uniformity of the HOE.

One embodiment is method of measuring quality of the focusing optical properties of a holographic optical element (HOE) comprising: (a) illuminating an active area of an HOE with incoherent light of a very narrow wavelength range, wherein the HOE diffracts the light into a camera or onto an image screen; and (b) detecting an image depicting quality or uniformity of the HOE at different positions by means of one or more translations in space. The system for carrying out the method includes an incoherent light source, optical transformation optics, a narrow band filter, and a camera or an image screen.

Another embodiment includes a method of assaying the quality of a population of holographic optical elements comprising illuminating an HOE with light having a very narrow wavelength range, wherein the light is diffracted back into a camera or onto an image screen, and detecting quality of an image for each member of the population of holographic optical elements. The system for carrying out the method includes an incoherent light source, optical transformation optics, a narrow band filter, and a camera or an image screen.

The apparatus described above can be modified to measure the focal and optical aberration properties of a focusing HOE. To accomplish this, the apparatus illuminates the active area of the HOE with incoherent light of a very narrow wavelength range, so as to simulate laser illumination of the HOE and the corresponding image without actually using a laser light. The HOE then diffracts this light and the diffracted beam can be imaged on a piece of paper, screen or with a camera sensor to provide an image. By moving the camera in space, spot size, uniformity and quality of the HOE for different positions of the camera.

The individual components of another embodiment of this system, as shown in FIG. 4, can include:

Incoherent light source. The incoherent light source is a white LED.
Optical transformation optics: the optics transform the light source wavefront into a wavefront suitable to assess the holographic optical element. The transformation optics should be able to control the parameters of the output wavefront such as spot size, wavefront aberration, etc. of the incident illumination. The transformation optics is a single lens.
Narrow band filter. A narrow-band filter reduces the light incident on the sample to a very narrow bandwidth (2-3 nm) as to simulate laser light without coherence self-interference.
Camera or an image screen: In the case of a camera, the sensor should have sufficient resolution to capture the details of the image required.
Translation stages: The camera or screen is mounted on translation stages that allow to characterize the diffracted beam in one or more spatial dimensions.

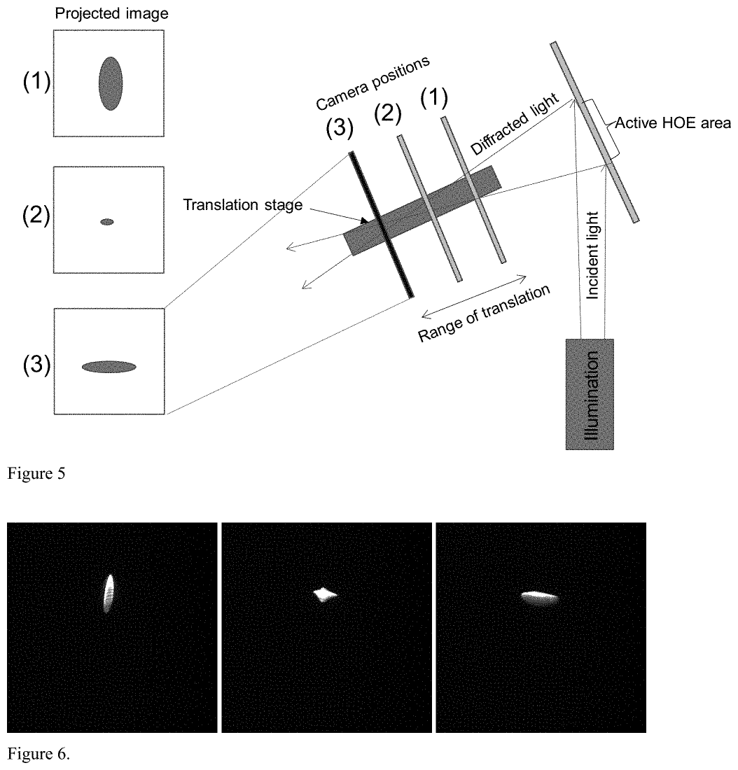

FIG. 5 shows a system in which the camera is translated in one dimension using a translation stage with a translation axis parallel and colinear with the diffracted light from the HOE. In the diagram of FIG. 5, the minimum spot size (focal point) is found in position 2 while the degree of astigmatism is found by comparing the spot diameter in x and y along the range of translation.

The system above can be used to measure the focal spot size and optical aberrations of a holographic optical element by illuminating the active area of an HOE with incoherent light of a very narrow wavelength range wherein the HOE diffracts the light; measuring the light diffracted by the HOE into a camera or onto an image screen at multiple positions; detecting an image depicting quality or uniformity of the HOE at each camera position; and analyzing the differences between the images at different positions.

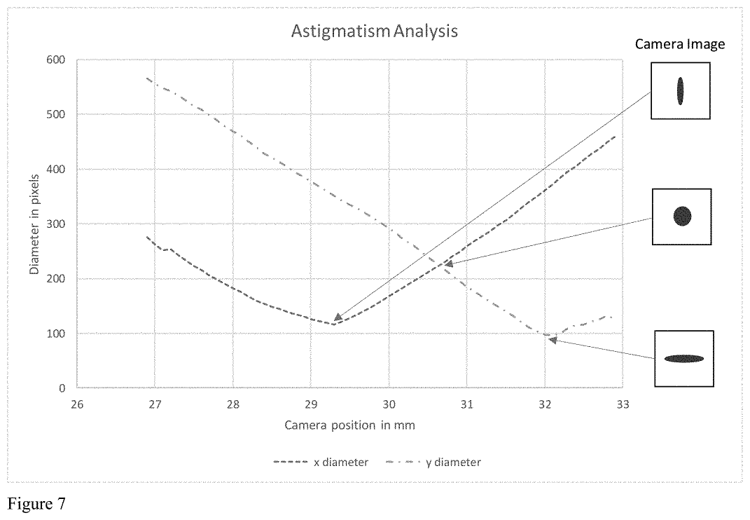

FIG. 6 shows images from HOE measurement for minimum diameter spot size in x (left), x and y (center) and y (right). FIG. 7 shows astigmatism analysis from images from camera translation.

Alternative embodiments of the subject matter of this application will become apparent to one of ordinary skill in the art to which the present invention pertains without departing from its spirit and scope. It is to be understood that no limitation with respect to specific embodiments shown here is intended or inferred.

We claim:

1. A system for analyzing quality of a holographic optical element comprising an incoherent light source, optical transformation optics, a narrow band filter, and a camera or an image screen.

2. The system of claim 1 where the optical transformation optics comprises a fiber optic cable.

3. The system of claim 1 where the optical transformation optics comprises one or more lenses.

4. The system of claim 1 where the optical transformation optics comprises a spatial filter.

5. The system of claim 1 where the optical transformation optics comprises a spatial filter, a fiber optic cable, one or more lenses, or a mixture thereof.

6. A method of measuring quality of a holographic optical element (HOE) comprising:
(a) illuminating an active area of an HOE with incoherent light of a very narrow wavelength range, wherein the HOE diffracts the light into a camera or onto an image screen; and (b) detecting an image depicting quality or uniformity of the HOE.

7. The method of claim 6 comprising an incoherent light source, optical transformation optics, a narrow band filter, and a camera or an image screen.

8. The method of claim 7 where the optical transformation optics comprises a fiber optic cable.

9. The method of claim 7 where the optical transformation optics comprises one or more lenses.

10. The method of claim 7 where the optical transformation optics comprises a spatial filter.

11. The method of claim 7 where the optical transformation optics comprises a spatial filter, a fiber optic cable, one or more lenses, or a mixture thereof.

12. A system for analyzing quality of the focusing optical properties of a holographic optical element comprising an incoherent light source, optical transformation optics, a narrow band filter, one or more translation stages and a camera or an image screen.

13. The system of claim 12 where the optical transformation optics is fiber optic cable.

14. The system of claim 12 where the optical transformation optics is a telescope.

15. The system of claim 12 where the optical transformation optics is a spatial filter.

16. The system of claim 12 where the optical transformation optics comprises a spatial filter, a fiber optic cable, one or more lenses, or a mixture thereof

17. A method of measuring quality of the focusing optical properties of a holographic optical element (HOE) comprising: (a) illuminating an active area of an HOE with incoherent light of a very narrow wavelength range, wherein the HOE diffracts the light into a camera or onto an image screen; and (b) detecting an image depicting quality or uniformity of the HOE at different positions by means of one or more translations in space.

18. The method of claim 17 comprising an incoherent light source, optical transformation optics, a narrow band filter, and a camera or an image screen.

19. A method of assaying the quality of a population of holographic optical elements comprising illuminating an HOE with light having a very narrow wavelength range, wherein the light is diffracted back into a camera or onto an image screen, and detecting quality of an image for each member of the population of holographic optical elements.

20. The method of claim 19 comprising an incoherent light source, optical transformation optics, a narrow band filter, and a camera or an image screen.
